(19) United States
(12) Patent Application Publication
(10) Pub. No.: US 2017/0132658 A1
(43) Pub. Date: May 11, 2017

(54) METHOD AND APPARATUS FOR MEASURING EFFECT OF INFORMATION DELIVERED TO MOBILE DEVICES

(71) Applicant: xAd, Inc., New York, NY (US)

(72) Inventors: Huitao Luo, Fremont, CA (US); Vimpy Batra, Mountain View, CA (US); Richard Chiou, San Jose, CA (US); Pravesh Katyal, Mountain View, CA (US)

(21) Appl. No.: 15/289,104

(22) Filed: Oct. 7, 2016

Related U.S. Application Data
(60) Provisional application No. 62/238,122, filed on Oct. 7, 2015.
(60) Provisional application No. 62/353,036, filed on Jun. 22, 2016.

(51) Int. Cl. G06Q 30/02; H04W 4/02

(52) U.S. Cl. CPC G06Q 30/0246; H04W 4/028; G06Q 30/0275

(57) ABSTRACT

The present disclosure provides method and apparatus for measuring effect of information delivered to mobile devices. In certain embodiments, a method performed by one or more computer systems coupled to a packet-based network comprises receiving a first plurality of request data packets via the packet-based network, receiving panel data packets via the packet-based network, and selecting a set of calibration mobile devices from the first plurality of mobile devices, each of the set of calibration mobile device having transmitted at least one of the panel data packets. The calibration mobile devices are used to derive a calibration factor. The method further comprises tracking a first number of mobile devices that have been served specific information to determined a second number of exposed memory devices having visited at least one of one or more pre-defined places, and calculating a measure of an effect of the specific information delivered to the first number of mobile devices using the first number, the second number and the calibration factor.

### CROSS REFERENCE TO RELATED APPLICATIONS

The present application claims the benefit and priority of U.S. Provisional Patent Application No. 62/238,122, filed Oct. 7, 2016, and U.S. Provisional Patent Application No. 62/353,036, filed Jun. 22, 2016, each of which is incorporated herein by reference in its entirety.

### FIELD

The present disclosure is related to information services, and more particularly to methods and apparatus for measuring effect of information delivered to mobile devices.

### DESCRIPTION OF THE RELATED ART

Smart phones and other forms of mobile devices are becoming more and more widely used. Nowadays, people use their mobile devices to stay connected with other people and to obtain information and services provided by publishers and application developers. To keep the information and services free and low-cost, publishers and application developers fund their activities at least partially by delivering sponsored information to the mobile devices that are engaging with them. The sponsored information is provided by sponsors who are interested in delivering relevant information to mobile users' mobile devices based on their locations. As mobile device uses become more and more popular, it is important for the information sponsors to have accurate measurement of the effectiveness or performance (i.e., lift) of their information delivery campaigns.

Conventionally, panel-based approach has been used to measure information campaign performance. It involves a group of users signed up as panelists, who agree to share their behaviors either by participating in surveys or by agreeing to be tracked by some software. The behaviors of the panelists exposed to an information campaign are then compared with those not exposed to the information campaign to obtain a measurement of the campaign performance or lift. Panel-based measurement however has the following problems: (a) it requires a group of panelists; (b) the mixture of the panelists can be very different from the actual mixture of mobile users exposed to the campaign, causing bias in the lift analysis; and (c) it is expensive to maintain a large group of panelists required in order to avoid sampling errors. For example, if a Home Depot advertisement campaign is targeting mobile devices within one-mile radius from a Home Depot store, many of the exposed panelists would be more predisposed to visit the store than the unexposed panelists, resulting in a biased measurement of the ad lift. In general, any targeting attribute used for an information campaign can potentially cause such a bias.

### BRIEF DESCRIPTION OF THE DRAWINGS

FIG. 1 is a diagrammatic representation of a packet-based network according to embodiments.

FIG. 2 is a diagrammatic representation of a computer/server that performs one or more of the methodologies and/or to provide part or all of a system for lift measurement according to embodiments.

FIG. 3 is a diagrammatic representation of an lift measurement system according to certain embodiments.

FIG. 4 is a flowchart illustrating a method for processing an information request according to certain embodiments.

FIG. 5 is a flowchart illustrating a method for lift measurement according to certain embodiments.

FIG. 6 is a diagram illustrating three different categories of mobile devices (or users) according to certain embodiments.

FIG. 7 is a table illustrating exemplary content in a processed request database according to certain embodiments.

FIGS. 8A and 8B are bar charts illustrating possibly different composition of mobile users in a test group and a control group selected for lift analysis according to certain embodiments.

FIGS. 9A-9C are plots illustrating an information campaign flight, and exposure windows and attribution windows for determining test and control groups and for computing lifts during an information campaign.

FIG. 10 is a plot illustrating an information campaign flight and selection of a look-back window for computing a natural tendency measure to account for stronger tendency for targeted responses of users in the test group that is not attributed to exposures to an ad campaign.

FIG. 11 is a flowchart illustrating a frequency modeling method to project an actual targeted response rate of mobile users exposed to an information campaign according to certain embodiments.

FIG. 12 is a plot illustrating targeted response rate data points calculated for respective frequency buckets being fitted to a model function.

FIG. 13 is a diagram illustrating overlapping of qualified mobile devices (users) on a panel and qualified mobile devices (users) seen by an information server system.

FIG. 14 is a flowchart illustrating a panel-assisted method of estimating an actual targeted response rate according to certain embodiment.

### DESCRIPTION OF THE EMBODIMENTS

The present disclosure provides method and apparatus that measure the effective of information delivered to mobile devices. The method and apparatus allow mobile information sponsors to measure the effectiveness or performance of their information campaigns by detecting targeted responses of mobile users after exposure to the information, thus quantifying how the information campaigns influence mobile user behaviors.

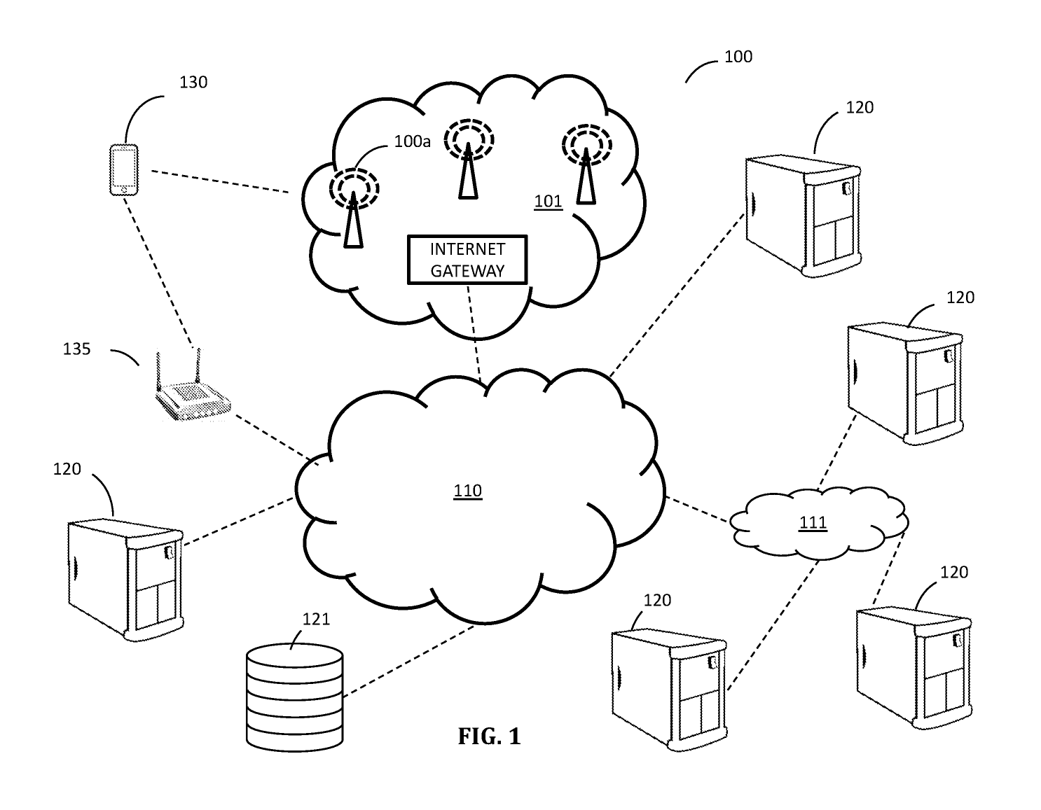

FIG. 1 illustrates a packet-based network 100 (referred to sometimes herein as “the cloud”), which, in some embodiments, includes part or all of a cellular network 101, the Internet 110, and computers/servers 120, coupled to the Internet (or web) 110. The computers/servers 120 can be coupled to the Internet 110 using wired Ethernet and optionally Power over Ethernet (PoE), WiFi, and/or cellular connections via the cellular network 101 including a plurality of cellular towers 101a. The network may also include one or more network attached storage (NAS) systems 121, which are computer data storage servers connected to a computer network to provide data access to a heterogeneous group of clients. As shown in FIG. 1, one or more mobile devices 130 such as smart phones or tablet computers are also coupled to the packet-based network via cellular connections to the cellular network 101, which is coupled to the Internet 110 via an Internet Gateway. When a WiFi hotspot (such as hotspot 135) is available, a mobile device 130 may connect to the Internet 110 via a WiFi hotspot 135 using its built-in WiFi connection. Thus, the mobile devices 130 may interact with other computers/servers coupled to the Internet 110.

The computers/servers 120 coupled to the Internet may include one or more publishers that interact with mobile devices running apps provided by the publishers, one or more information middlemen or information networks that act as intermediaries between publishers and information providers, one or more information servers that select and send information to the publishers to post on mobile devices, one or more computers/servers running information exchanges, one or more computers/servers that post mobile supplies on the information exchanges, and/or one or more information providers that monitor the information exchanges and place bids for the mobile supplies posted in the information exchanges. The publishers, as they interact with the mobile devices, generate the mobile supplies, which can be requests for information the form of data packets carrying characteristics of the mobile devices, certain information about their users, and raw location data associated with the mobile devices, etc. The publishers may post the mobile supplies on the information exchanges for bidding by the information or their agents, transmit the mobile supplies to an information agent or information middleman for fulfillment, or fulfill the supplies themselves.

One example of information service is to deliver advertisements to mobile devices as they interact with the publishers and application developers. Advertisers (information providers), agencies, publishers and ad middlemen can also purchase mobile supplies through ad exchanges. Ad networks and other entities also buy ads from exchanges. Ad networks typically aggregate inventory from a range of publishers, and sell it to advertisers for a profit.

An ad exchange is a digital marketplace that enables advertisers and publishers to buy and sell advertising space (impressions) and mobile ad inventory. The price of the impressions can be determined by real-time auction, through a process known as real-time bidding. That means there's no need for human salespeople to negotiate prices with buyers, because impressions are simply auctioned off to the highest bidder. These processes take place in milliseconds, as a mobile device loads an app or webpage.

Advertisers and agencies can use demand-side platforms (DSP), which are softwares that use certain algorithms to decide whether to purchase a certain supply. Many ad networks now also offer some sort of DSP-like product or real-time bidding capability. As online and mobile publishers are making more of their inventory available through exchanges, it becomes more cost efficient for many advertisers to purchase ads using DSPs.

An ad server is a computer server, e.g., a web server, backed by a database server, that stores advertisements used in online marketing and place them on web sites and/or mobile applications. The content of the webserver is constantly updated so that the website or webpage on which the ads are displayed contains new advertisements—e.g., banners (static images/animations) or text—when the site or page is visited or refreshed by a user. In addition to selecting and delivering ads to users, the ad servers also manage website advertising space and/or to provide an independent counting and tracking system for advertisers. Thus, the ad servers provide/serve ads, count them, choose ads that will make the websites or advertisers most money, and monitor progress of different advertising campaigns. Ad servers can be publisher ad servers, advertiser ad servers, and/or ad middleman ad servers. An ad server can be part of the same computer or server that also act as a publisher, advertiser, and ad middleman.

Ad serving may also involve various other tasks like counting the number of impressions/clicks for an ad campaign and generating reports, which helps in determining the return on investment (ROI) for an advertiser on a particular website. Ad servers can be run locally or remotely. Local ad servers are typically run by a single publisher and serve ads to that publisher's domains, allowing fine-grained creative, formatting, and content control by that publisher. Remote ad servers can serve ads across domains owned by multiple publishers. They deliver the ads from one central source so that advertisers and publishers can track the distribution of their online advertisements, and have one location for controlling the rotation and distribution of their advertisements across the web.

The computer/servers 120 can include server computers, client computers, personal computers (PC), tablet PC, set-top boxes (STB), personal digital assistant devices (PDA), web appliances, network routers, switches or bridges, or any computing devices capable of executing instructions that specify actions to be taken by the computing devices. As shown in FIG. 1, some of the computers/servers 120 are coupled to each other via a local area network (LAN) 110, which in turn is coupled to the Internet 110. Also, each computer/server 120 referred herein can include any collection of computing devices that individually or jointly execute instructions to provide one or more of the systems discussed herein, or to perform any one or more of the methodologies or functions discussed herein, or to act individually or jointly as one or more of a publisher, an advertiser, an advertisement agency, an ad middleman, an ad server, an ad exchange, etc, which employs the systems, methodologies, and functions discussed herein.

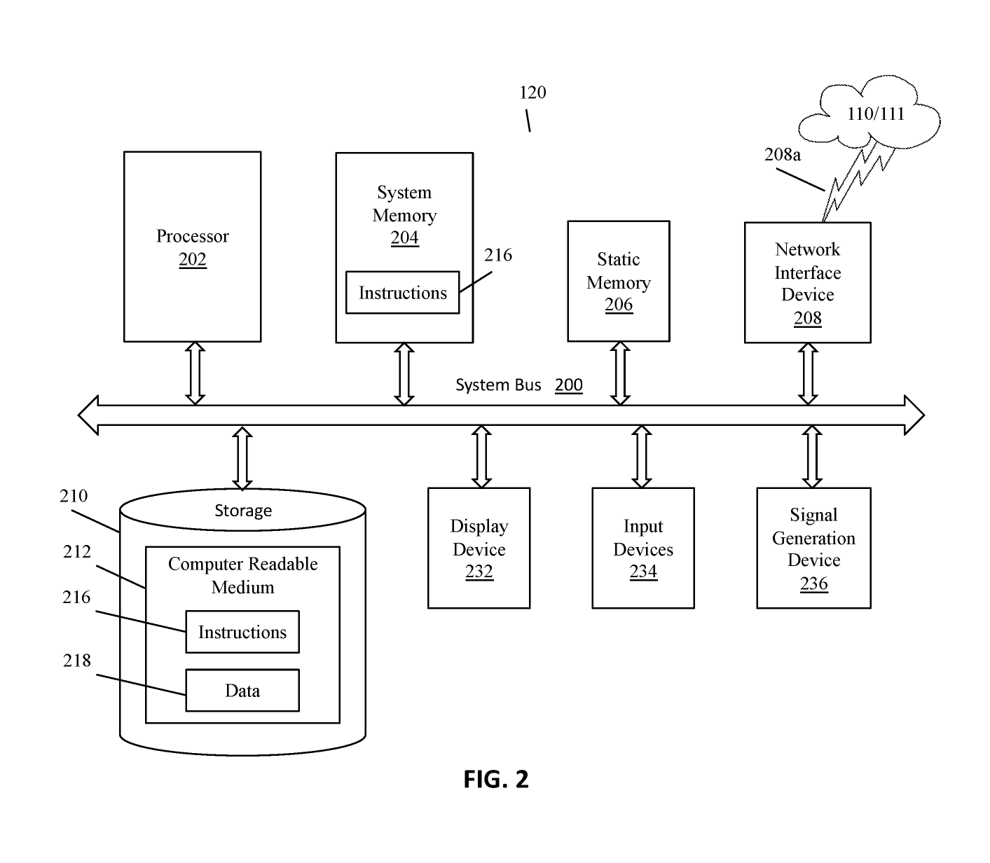

FIG. 2 illustrates a diagrammatic representation of a computer/server 120 that can be used to provide a system and/or perform a method for ad lift measurement, by executing certain instructions. The computer/server 120 may operate as a standalone device or as a peer computing device in a peer-to-peer (or distributed) network computing environment. As shown in FIG. 2, the computer/server 120 includes one or more processors 202 (e.g., a central processing unit (CPU), a graphic processing unit (GPU), and/or a digital signal processor (DSP)) and a system or main memory 204 coupled to each other via a system bus 200. The computer/server 120 may further include static memory 206, a network interface device 208, a storage unit 210, one or more display devices 230, one or more input devices 234, and a signal generation device (e.g., a speaker) 236, with which the processor(s) 202 can communicate via the system bus 200.

In certain embodiments, the display device(s) 230 include one or more graphics display units (e.g., a plasma display panel (PDP), a liquid crystal display (LCD), a projector, or a cathode ray tube (CRT)). The input device(s) 234 may include an alphanumeric input device (e.g., a keyboard), a cursor control device (e.g., a mouse, trackball, joystick, motion sensor, or other pointing instrument). The storage unit 210 includes a machine-readable medium 212 on which is stored instructions 216 (e.g., software) that systems, methods or functions for store lift measurement described herein. The storage unit 210 may also store data 218 used and/or generated by the systems, methodologies or functions. The instructions 216 (e.g., software) may be loaded, completely or partially, within the main memory 204 or within the processor 202 (e.g., within a processor's cache memory) during execution thereof by the computer/server 120. Thus, the main memory 204 and the processor 1102 also constituting machine-readable media.

While machine-readable medium 212 is shown in an example implementation to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., instructions 216) for execution by the computer/server 120 and that cause the computing device 1100 to perform anyone or more of the methodologies disclosed herein. The term “machine-readable medium” includes, but not be limited to, data repositories in the form of solid-state memories, optical media, and magnatic media. In certain embodiments, the instructions 216 and/or data 218 can be stored in the network 100 and accessed by the computer/server 120 via its network interface device 208, which provides wired and/or wireless connections to a network, such as a local area network 111 and/or a wide area network (e.g., the Internet 110) via some type of network connectors 280a. The instructions 216 (e.g., software) and or data 218 may be transmitted or received via the network interface device 208.

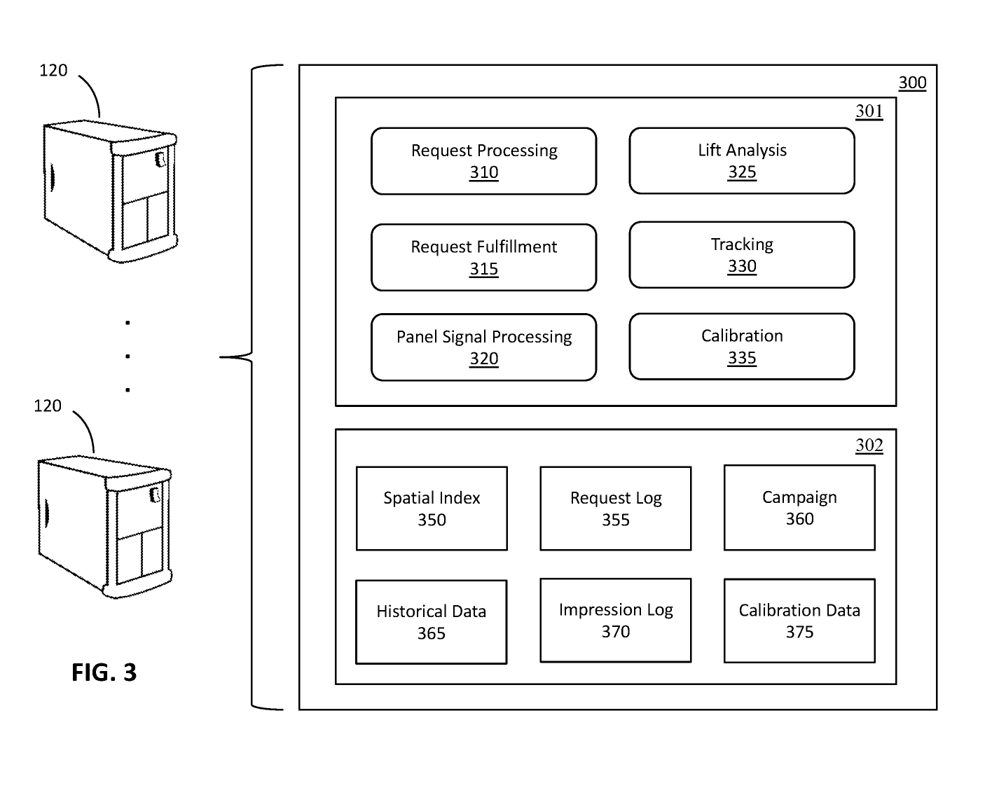

FIG. 3 is a diagrammatic representation of lift measurement system (LMS) 300 provided by one or more computer/server systems 120 coupled to each other either locally or remotely via the network 110 according to certain embodiments. As shown in FIG. 3, the processor(s) 202 in the computer/server system(s) 120, when executing one or more software programs 301 loaded in their respective main memory or memories 204, provides a set of modules including a request processing module 310, a request fulfillment module 315, a panel signal processing module, a lift analysis module 325, a tracking module 330, and a calibration module 335. The system 300 makes use of a plurality databases 302 storing data used and/or generated by the LMS 300, including a spatial index database 350 storing therein spatial indices for predefined places corresponding to respective points of interests, a request log database 355 storing therein processed requests from the request processing module 310, a campaign database 360 for storing therein campaign information such as campaign criteria and campaign documents or links to campaign documents for serving to the mobile devices, a historical data store 365 storing therein historical data related to activities of the mobile devices seen by the request processing module 310, an impression log files database 370 for storing log files generated by the request fulfillment module 315, and calibration database storing therein calibration data such as calibration panel information and results generated by the calibration module. Any or all of these databases can be located in the respective storage(s) 210 of that one or more computer/server systems that provide the modules in the LMS 300, or in another server/computer 120 and/or NAS 121 in the network 100, which the processor(s) 202 can access via the network interface device 208.

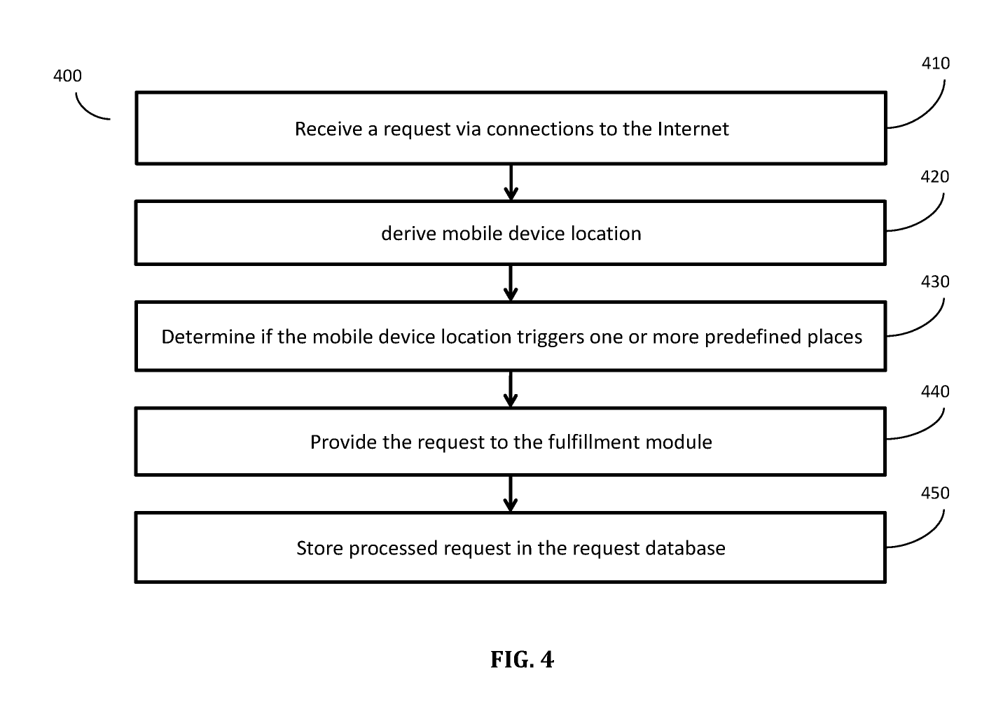

In certain embodiments, the request processing module 310 receives and processes information requests presented by an information server, e.g., mobile publishers, ad middleman, and/or ad exchanges, etc. via the network 110. Each information request is related to a mobile device and arrives at the LMS 300 in the form of, for example, a data packet including data unites carrying respective information, such as identification of the mobile device (or its user) (UID), maker/model of the mobile device (e.g., iPhone 6S), an operating system running on the mobile device (e.g., iOS 10.0.1), attributes of a user of the mobile device (e.g., age, gender, education, income level, etc.), location of the mobile device (e.g., city, state, zip code, IP address, latitude/longitude or LL, etc.). The request data packet may also include a request time stamp, a request ID, and other data/information. As described in co-pending U.S. patent application Ser. No. 14/716,811, filed May 19, 2015, entitled “System and Method for Marketing Mobile Advertising Supplies,” which is incorporated herein by reference in its entirety, the request processing module 310 in certain embodiments performs a method 400 for processing the request data packet, as illustrated in FIG. 4. The method 400 comprises receiving an information request via connections to a network such as the Internet (410), deriving a mobile device location based on the location data in the information request (420), determining if the mobile device location triggers one or more predefined places or geo-fences (430), providing the processed request to an ad serving system (440), and storing the processed request in the request database 350 for ad lift analysis.

In certain embodiments, deriving the mobile device location (420) comprises processing the location information in the requests using the smart location system and method described in co-pending U.S. patent application Ser. No. 14/716,816, filed May 19, 2015, entitled “System and Method for Estimating Mobile Device Locations,” which is incorporated herein by reference in its entirety. The derived mobile device location is used to search in the spatial index database 350 for one or more places in which the mobile device related to the request may be located. If the ad request is found to have triggered one or more places in the spatial index database 350, the request is annotated with tags corresponding to the one or more places, the tags identifying business/brand names, categories of the products or services associated with the business/brand names, and place types (e.g., store, parking lot, street block, etc.), resulting in an annotated request. The processed requests are stored in the request log 355.

In certain embodiments, the request fulfillment module 315 compares the annotated request 410 with the matching criteria of a number of information campaigns stored in the campaign database 360. Upon determining that the data units and tags in the annotated requests matches one or more information campaigns and preset budget of the one or more information campaigns has not run out, the request fulfillment module 315 selects one or the one or more information campaign (sometimes taking in consideration historical data about the behavior of the related mobile device (user) stored in the historical data database 365), fulfills the request by attaching a link to a document associated with one of the one or more information campaigns to the annotated request, and transmits the annotated request to the information server, e.g., mobile publishers, ad middleman, and/or ad exchanges, etc. via the network 110. The request fulfillment module 315 also monitors feedbacks from the information server indicating whether the document associated with the one or more information campaigns has been delivered to (or impressed upon) the related mobile device and stores the feedback in the impression log 370.

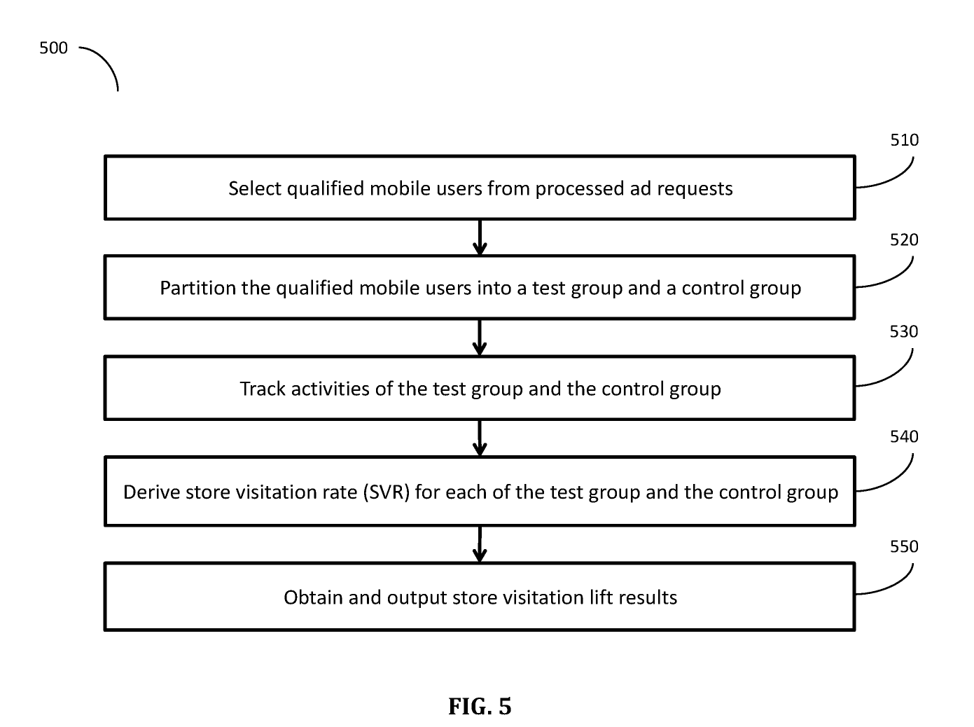

FIG. 5 illustrates a method 500 performed by the lift analysis module 325 for measuring performance of information campaigns without using static panels. According to certain embodiments, method 500 comprises identifying (510) qualified requests as the request fulfillment module 315 are processing information requests in real-time or afterwards from the request log 355 and/or impression log 370, partitioning (520) mobile devices associated with the qualified requests into a test group and a control group, tracking (530) activities for the test group and control group, deriving (540) targeted response rate (e.g., store visitation rate) (SVR) for each of the test group and the control group, and obtaining (550) lift results from the store visitation rates.

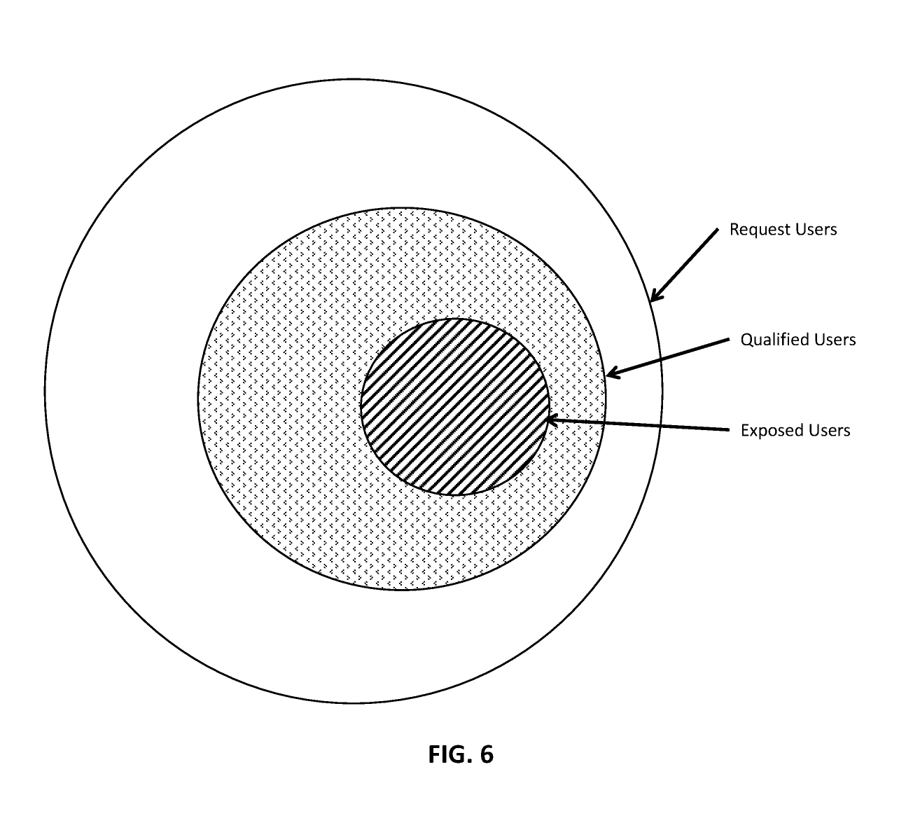

As shown in FIG. 5, as the requests are being processed or afterwards, the mobile devices (or their users) associated with the requests are categorized by the lift analysis module 325 into three groups: the request users, the qualified users and the exposed users. FIG. 6 visualizes the relationship between request users, qualified users and exposed users for a given information campaign. Each of the request users can be any user who is associated with at least one request during the flight of the information campaign. Out of the request users, those who are associated with information requests that qualify for the information campaign are referred to as the qualified users. In certain embodiments, an information request qualifies for the information campaign if it meets certain targeting criteria (demographic, time of the day, location, etc) of the information campaign.

In typical ad serving systems based on Real Time Bidding (RTB), a qualifying request does not always get fulfilled and thus results in an impression event. For example, an ad campaign may run out of daily budget, or the same request qualifies for more than one campaigns, or the request fulfillment module 315 does not win the bidding, especially in an RTB pricing competition, or the creative (document) specified by the request fulfillment module 315 fails to impress on the associated mobile device due to incompatibility issues, etc. Thus, out of the qualified users, those who have been shown the ads in response to the associated requests are categorized as the exposed users.

Thus, the lift analysis module 325 determines mobile device groups for lift measurements based on data in the request log 355 and/or the impression log. The lift analysis module 325 partitions users and/or devices into a control group (control panel) and a test group (test panel) for a respective information campaign, where a user and/or device is represented by a UDID, IDFA or GIDFA for mobile phones, or by a cookie or login id associated with a publisher. Both panels are dynamically extracted from the requests seen by the ad delivery systems during a flight of the information campaign.

In certain embodiments, the lift analysis module 325 selects all or a subset of the exposed users as the test panel, and selects all or a subset of the qualified users who are not exposed users as the control panel. In certain embodiments, the lift analysis module 325 includes a tagging function and an aggregation function. The tagging function runs in conjunction with the request fulfillment module 315, which generates the request log 355 and the impression log 370.

The request log 355 keeps track of requests and the information campaigns for which they qualify, in the form of, for example, a tuple of (user_id, ad_1, ad_2, . . . , ad_n) for each qualifying request, where user_id represents the mobile user of the request, and (ad_1, ad_2, . . . , ad_n) indicates the information campaigns for which the request qualified. The impression log 370 records each user successfully impressed with the relevant information associated with an information campaign, which is presented as an array of (user_id, ad_id) pairs according to certain embodiments.

The lift analysis module 325 processes the request log 355 and the impression log 370 for each information campaign to determine a list of users who have been exposed to the campaign as the test group, and a list of users who qualify for the campaign, but not exposed to the campaign as the control group.

Given the test group and control group, the tracking module 330 measures the targeted responses of the users in both groups, such as store visitation, purchase, etc. that occur after mobile users in the groups have been determined to be qualified users. The tracking module 330 makes use of the control group and test group data in the request database 355 and some third party data or first party data obtained via the network 110 and/or stored in the request database 355 to obtain records of the post-exposure activities of users in the control group and the test group. The third party data could be user purchase activities tracked by online tracking pixels on check-out pages, or tracked by mobile payment software such as Paypal. The purchase activities could also be obtained from first party data such as sales reports coming directly from the advertisers.

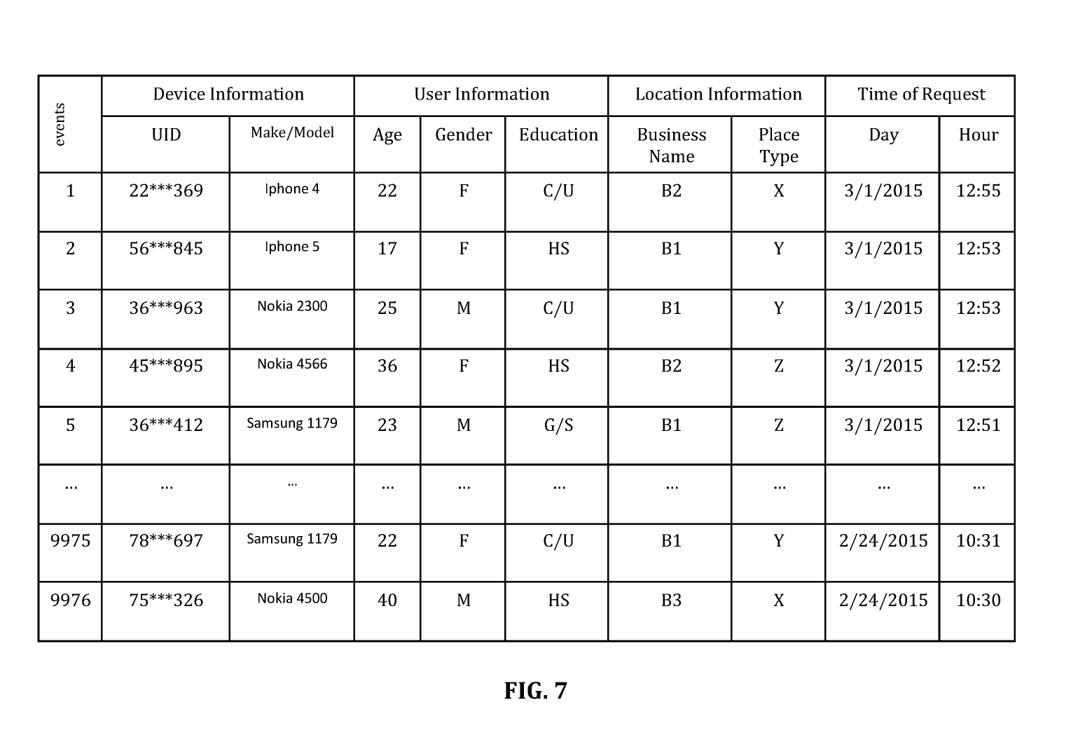

In certain embodiments, the interested user activity is store visitation (SV), and the type of information campaigns are mobile advertising (ad) campaigns, where the ad requests include mobile user location information. In certain embodiments, the store visitation (SV) activities of the test group users and the control group users can be derived from their associated subsequent ad requests logged in the requests database 355. FIG. 7 illustrates examples of logged requests in the requests database, which includes, for each logged request, the user ID (UID) or device ID, the maker/model of the mobile device, the age, gender and education level, etc. of the mobile user, one or more business/brand names the device location has triggered, the type of place the device location has triggered (e.g., type X for business premise, type Y for parking lot or shopping center near the business, and type Z for street block in which the business is located, etc.), and the time of the request, etc. In certain embodiments, the business/brand names associated with an ad request is derived using a method described in co-pending U.S. patent application Ser. No. 14/716,811, filed May 19, 2015, entitled “System and Method for Marketing Mobile Advertising Supplies,” which is incorporated herein by reference in its entirety. In certain embodiments, the tracking module 330 searches through the logged requests to look for entries associated with mobiles users in the control group and test group and to check if these entries also include device locations and/or business/brand name(s) that indicate store visitation events desired by the ad campaign.

In some embodiment, an SV event is attributed to a user in the test group only if the visit occurs within a specified period (e.g., 2 weeks) after the impression was made. Similarly, an SV event is attributed to a user in the control group only if the visit occurs within a specified period after the user has been qualified for the ad. In some embodiments, “employees” of a store are derived from frequency and/or duration of associated SV events, and are removed from test and control groups.

In certain embodiments, the lift-analysis module derives activities metrics for the control group and the test group and generates store visitation lift results. For example, a store visitation rate metric can computed for each of the test group and the control group as follows:

$$SVR = \frac{( Number\_of \_Unique \_Users \_Who \_Visted \_the \_Targeted \_Store )}{( Number\_of \_Unique \_Users \_in \_the \_Group )}$$

In certain embodiments, if there are multiple exposures followed by a visit, only one visit is considered in the above SVR calculation. In certain embodiments, if there are multiple visits following an exposure, only one visit is considered in the above SVR calculation.

A store visitation lift measure can be computed as:

$$SVL = \frac{SVR\_test}{SVR\_control} - 1$$

If the performance goal is purchase, a corresponding set of metrics could be defined for performance measure.

The above calculation is based on the assumption that the test panel and the control panel are balanced over major meta data dimensions. In certain embodiments, the partition module 310 is built to make sure the panel selection process is balanced over major meta data dimensions. For example, if a campaign is not targeting by gender, then the partition module has to make sure that the control panel and the test panel should have an equal mixture of male and female in order to remove gender bias. If a campaign is not targeting any particular traffic sources (a mobile application or a website), the panel selection should also avoid skewed traffic source distributions between two panels.

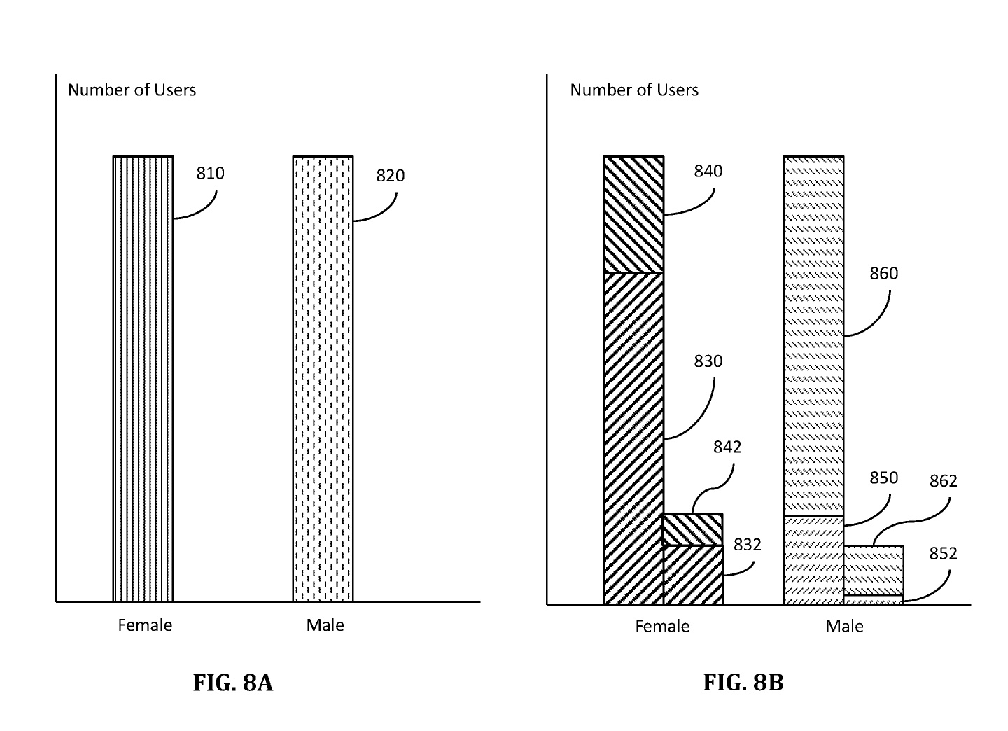

FIGS. 8A and 8B illustrate examples of how gender bias can be created during the panel selection process, which can result in skewed ad lift calculations. As shown in FIG. 8A, if a campaign is not targeting by gender, then the qualified users should include about equal numbers of male users (810) and female users (820). In practice, however, the ad serving process may create gender bias, resulting in the control panel and the test panel having unequal female/male ratios. For example, FIG. 8B illustrates an apparent imbalance in the female/male ratios for the test panel and the control panel. As shown in FIG. 8B, block 830 represents the number of female users exposed to the campaign and thus allocated to the test group while block 840 represents the number of female users not exposed to the campaign and thus allocated to the control group. Likewise, block 850 represents the number of male users exposed to the campaign and thus allocated to the test group while block 860 represents the number of male users not exposed to the campaign and thus allocated to the control group.

Referring still to FIG. 8B, block 832 represents the users in block 830 that have had at least one post-exposure SV event, while block 842 represents the users in block 840 that have had at least one SV event without any exposure to the ad campaign. Likewise, block 852 represents the users in block 850 that have had at least one post-exposure SV event, while block 862 represents the users in block 860 that have had at least one SV event without any exposure to the ad campaign. To illustrate how the imbalance shown in FIG. 8B can generate skewed or even erroneous ad lift results, assuming that the total number of qualified users is 2000 including 1000 female users in block 810 and 1000 male users in block 820 in FIG. 8A, Table I below lists exemplary numbers of users in the blocks in FIG. 8B.

As shown in Table I, because of the imbalance of the female/male ratios in the test group and the control group, even though exposure to the ad campaign did not make any difference in the percentage of male or female users having had SV events (in both the test group and control group, the percentage of female users having had SV events is about 20% and the percentage of male users having had SV events is about 10%), the SVL calculation still produced a positive result, indicating an ad lift.

In certain embodiments, to avoid generating such skewed or erroneous lift results, the partition module 310 is configured to insure balance over major meta data dimensions. For example, in the case shown in FIG. 8B, the partition module 310 can remove a portion (e.g. 500) of the female users in the test group and a portion (e.g. 500) of the male users in the control group to insure balance in the female/male ratios in the two groups, as shown in Table II.

Alternatively, especially when there is not an ample number of qualified users, it would be better to keep the number of users in each panel and make adjustment during the analysis stage. For example. The lift analysis module can multiply the numbers of users in the less populated meta data sections to create an artificial balance between the groups, as shown in Table III.

TABLE I

| | Test | | Control | |
|---|---|---|---|---|
| | F | M | F | M |
| Number of Users in | 750 | 250 | 250 | 750 |
| Group | | | | |
| Number of Users with | 150 (20%) | 25 (10%) | 50 (20%) | 75 (10%) |
| SV events | | | | |

| | | |
|---|---|---|
| SVR | 175/1000 = 0.175 | 125/1000 = 0.125 |

| | |
|---|---|
| SVL | 0.175/0.125 − 1 = 0.4 |

TABLE II

| | Test | | Control | |
|---|---|---|---|---|
| | F | M | F | M |
| Number of Users in | 250 | 250 | 250 | 250 |
| Group | | | | |
| Number of Users with | 50 (20%) | 25 (10%) | 50 (20%) | 25 (10%) |
| SV events | | | | |

| | | |
|---|---|---|
| SVR | 75/500 = 0.15 | 75/500 = 0.15 |

| | |
|---|---|
| SVL | 0.15/0.15 − 1 = 0 |

TABLE III

| | Test | | Control | |
|---|---|---|---|---|
| | F | M | F | M |
| Number of Users in | 750 | 750 | 750 | 750 |
| Group | | | | |
| Number of Users with | 150 (20%) | 75 (10%) | 150 (20%) | 75 (10%) |
| SV events | | | | |

| | | |
|---|---|---|
| SVR | 225/1000 = 0.225 | 225/1000 = 0.225 |

| | |
|---|---|
| SVL | 0.225/0.225 − 1 = 0 |

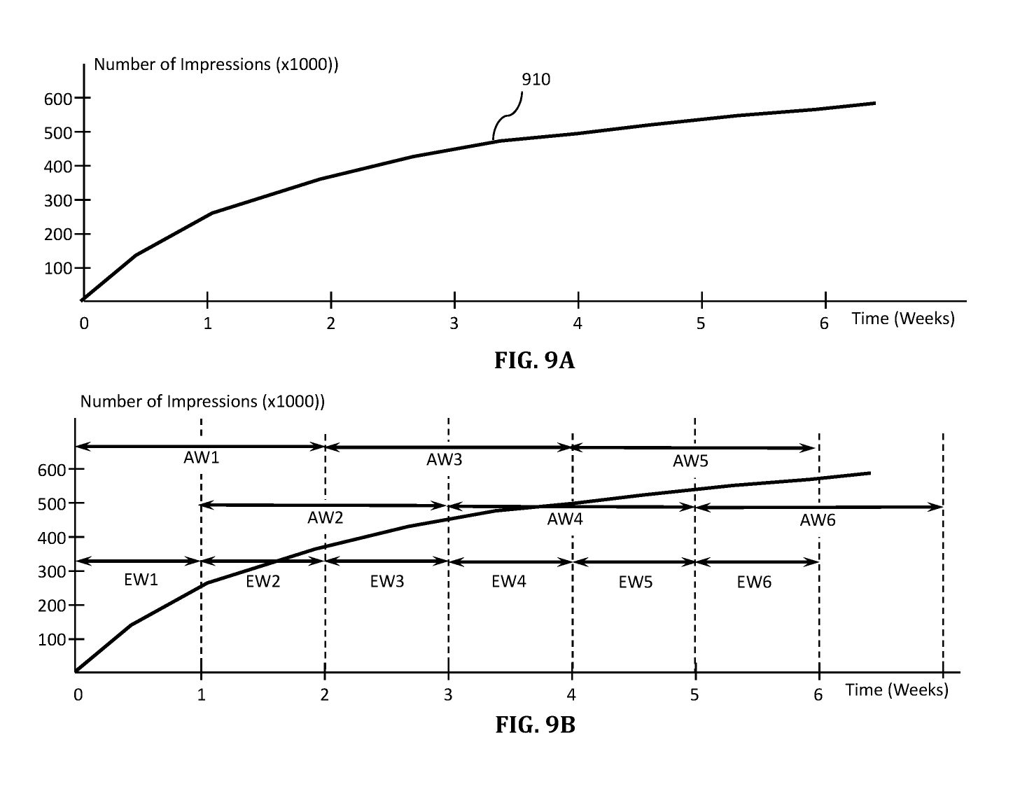

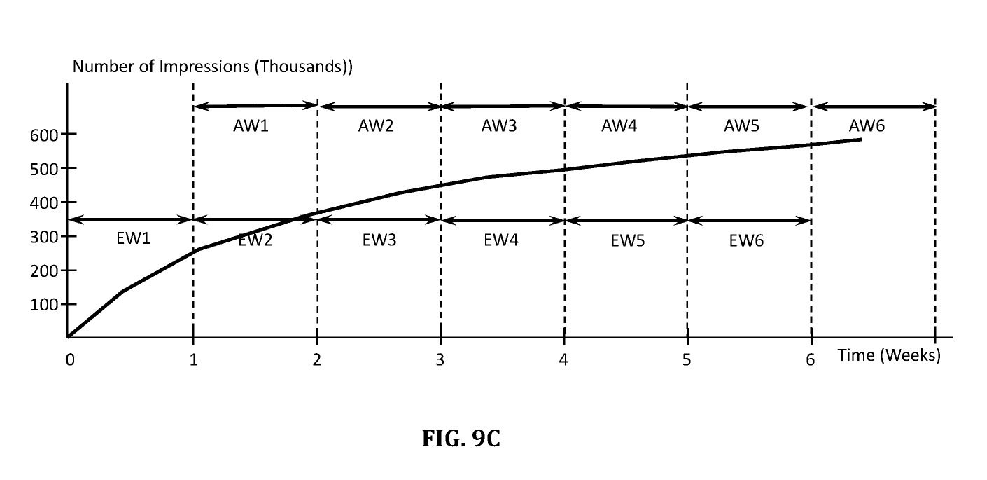

In certain embodiments, an ad campaign flight (i.e., duration of an ad campaign) is divided to include multiple windows, and store visit lift is first calculated for each window and then averaged over the multiple windows to arrive at the final lift. This approach is necessitated by the fact that there is a greater chance for a user to be in the test user group as the ad campaign proceeds. For example, an ad campaign flight may last several weeks, with an increasing number of mobile users becoming exposed to the ad campaign as the number of impressions increase over the course of time, as illustrated by the curve 910 in FIG. 9A. Thus, if the test group and control group are determined based on the ad requests received during the whole flight of the campaign, a skew in the sizes of the control and test user groups may result because a user not exposed to the ad campaign during the 1st week of the ad campaign may encounter the ad campaign in subsequent weeks. Note that a mobile user can be exposed to the ad campaign multiple times during the campaign flight, so the number of impressions in FIG. 9A do not necessarily equal to the number of exposed mobile users.

To overcome this skew, as shown in FIG. 9B, the flight of the ad campaign is divided to include multiple exposure windows, e.g., EW1, EW2, . . . , and EW6, each is associated with a visit attribution window, e.g., AW1, AW2, . . . , and AW6, respectively. For each exposure window, the control user panel and test user panel is determined based on ad requests and ad delivery during the exposure window, and a lift is computed based on store visits during the associated visit attribution window. The panelists and store visit lift metric for each exposure window are determined as described above. An overall visit lift is computed by averaging over the multiple exposure windows, as shown below:

SVL=Average(SVLᵢ), where SVLᵢ is the lift computed for the i^{th} exposure window

Table IV shows an example of an overall SVL for an ad campaign computed using six exposure windows:

TABLE IV

| EW1 | EW2 | EW3 | EW4 | EW5 | EW6 | Overall |
|---|---|---|---|---|---|---|
| 5% | 10% | 15% | 10% | 5% | 15% | 10% |

In FIG. 9B, each lift attribution window (e.g., AW1) is shown to overlap with its associated exposure window (e.g., EW1). In this case, store visits occurring during an exposure window (e.g., EW1) as well as afterwards are considered in the calculation of the store visit lift for the exposure window (e.g., SVL₁), even though the test group and control group are determined at the end of the exposure window. In other embodiments, as shown in FIG. 9C, each lift attribution window (e.g., AW1) does not overlap with its associated exposure window (e.g., EW1). Thus, store visits occurring during an exposure window (e.g., EW1) are not considered in the calculation of the store visit lift for that exposure window (e.g., SVL₁).

In certain embodiments, the effect of an ad exposure on a user in the test group is made to decay over time. Thus, as the lag between ad exposure and store visitation increases, the effect of the ad exposure contributing to that visit decreases. To avoid over statement in the store visit lift calculation, a user who was in the test group initially can drift to the control group as the ad campaign proceeds unless that user is exposed to the ad campaign again. In certain embodiments, a decay function is defined which determines the contribution of a user to either the test group or the control group based on how long ago the user has been exposure to an ad campaign. A user is 100% in the test group the day the user is exposed to the ad campaign and this contribution percentage decreases as the ad campaign proceeds until the user is exposed again. The remaining percentage of the user is counted towards the control group. Thus, at the end of an exposure window, the number of users in the test group (N_{T}) and the number of users in the control group (N_{C}) can be computed as follows:

N_{T}=ΣF(T−Tⱼ), and

N_{C}=Σ(1−F(T−Tⱼ)),

where Tⱼ represents the time the j^{th} qualified user is exposed to the ad campaign, T represents the time at the end of the exposure window, F(T−Tⱼ) represents the decay function, and the sum is over the qualified users. The decay function can be a linear decay function, e.g.,

F(T−Tⱼ)=1−(T−Tⱼ)/(T−T₀),

where T₀ represents the beginning time of the exposure window. The decay function can also be an exponential function, e.g.,

F(T−Tⱼ)=e^{-(T-T}^{ⱼ}^{)/(T-T0)},

or any other decay function suitable for the particular ad campaign.

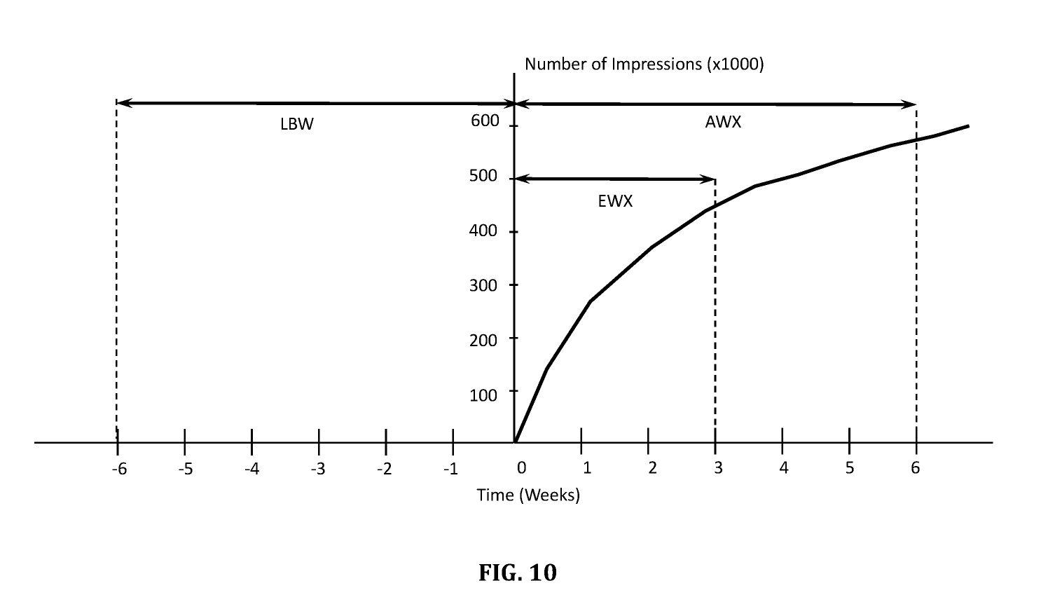

If an ad campaign is targeting users who have a stronger natural propensity to visit a store, the test group may be made of an unnaturally large percentage of such users and the lift computation may overstate the effect of ad campaign. In certain embodiments, the stronger natural tendency that some of the users in the test group have towards visiting a store associated with an ad campaign is computed and taken off the store visit lift computation, so as to avoid overstating the effect of the ad campaign. In certain embodiments, as shown in FIG. 10, to capture and remove the above-stated bias, store visit records of mobile users in a window of time (look-back window, or LBW) before the start of an ad campaign are examined and used to compute a natural tendency measure (NTM) for mobile users in the test group, even though these mobile users are allocated to the test group at the end of an exposure window (EWX) during the campaign.

In this process, a control user panel or control group and a test user panel or test group are determined based on qualifying ad requests processed during the exposure window (EWX). The lookback window (LBW) before the start of the campaign is selected to be immediately before the campaign and preferably of the same or similar size as an attribution window (AWX) associated with the EWX. The natural tendency measure (NTM) for the mobile users in the test group can be computed using one of the above-described methods for calculating store visitation lift, as if the users in the test group had been exposed to the ad campaign. In other words, store visit rates is computed for these two groups of users during the lookback window (LBW) before the start of the ad campaign, and are used to compute a “store visit lift” for the look-back window (SVL_{Look-Back}). The store visit lift (SVL_{campaign flight}) during the campaign flight is computed as described above, and the net store visit lift is measured as:

SVL=SVL_{campaign flight}−NTM, where NTM=SVL_{Look-Back}.

Table V illustrates an example of the results of a net store visit lift calculation that remove the bias caused by stronger natural tendencies for store visit of test group users.

TABLE V

| SVL_{campaign flight} | NTM | SVL |
|---|---|---|
| 20% | 10% | 10% |

In some other implementations, the LBW could be selected to be a window that is not necessarily immediate before the start of the campaign. For example, a LBW could be selected to be a window somewhere before the start of the campaign but having the same mixture of week days and weekend days as the EWX or AWX window.

Alternatively, instead of using the LBW, a hash function can be built into the request fulfillment module 315 to deliberately skip some users whom the advertiser would otherwise choose to impress (e.g., users with a user ID number having a last or first digit being “0”). In other words, instead of trying to impress as many favored users (e.g., users with stronger natural propensity to visit a store) as possible and thereby moving as many such users as possible into the test group and leaving the rest of the users in the control group, the ad serving process can be configured to randomly select a percentage (e.g., 10%) of the favored users to form the control group. Thus, the control group is made mostly of those favored users who have been skipped by the ad serving process and who would otherwise end up in the test group during an exposure window. Thus, the user profiles in the control group and the test group are almost identical.

Ideally, the test group and the control group should have about the same number of users. Such an ideal situation, however, cannot simply be achieved using a higher percentage (e.g., 50%) hash function because not all of the processed request sent to the an information server, e.g., mobile publishers, ad middleman, and/or ad exchanges, etc., actually result in impression. Thus, a 50% hash function would result in less users in the test group than in the control group and sacrifice of an excessive amount of request inventory to create the control group comprised of similar mobile users as in the test group. To resolve this issue, the request fulfillment module 315 uses a 10% hash function and includes a counter that keeps a count that reflects a different between the number of mobile users in the test group and the number of mobile users in the control group. Everytime when the feedback from the information server, indicate an impression in response to a favored request for a certain campaign, the count increases by 1, and everytime when a favored request is assigned to the control group, the count decreases by 1. The request fulfillment module 315 is designed such that this favored request is only assigned to the control group when the count is 1 or larger. Thus, in the beginning, more favored requests result in impressions than assigned to the control group and the count increases more than decreasing because of the 10% hash function. But, after the campaign starts to run out of budget, more favored requests are assigned to the control group than resulting in impressions, until the count reaches 0. Thus, not only that the user profiles in the control group and the test group are almost identical, the numbers of users in the control group and the test group are almost equal, ensuring that the bias caused by the ad serving process favoring certain users is removed.

Recall that SVR is calculated using the formula:

$$SVR = \frac{( Number\_of \_Unique \_Users \_Who \_Visted \_the \_Targeted \_Store )}{( Number\_of \_Unique \_Users \_in \_the \_Group )}$$

This calculation alone is not usually an actual representation of the effect of an ad campaign because, while the denominator is easily obtained by counting the number of users in a user group, the numerator does not usually represent the actual number of users in the user group who have visited a store because most of these users do not make their locations accessible all of the time. In a typical mobile ad network setup, a user's location (e.g., latitude and longitude, or LL) is shared with the ad servers only when an ad request associated with the mobile user is sent to the ad servers. If a user's mobile device is not running apps that send ad requests to the ad servers at the time of the user's store visitation, this visit is not visible to the LMS 300 and thus is not counted in the denominator of the SVR calculation. This is not much of a problem in the above store visitation lift calculations where store visitation lift measure is computed as:

$$SVL = \frac{SVR\_test}{SVR\_control} - 1 ,$$

where the ratio of SVR_test and SVR_control is used to compute SVL.

In some applications, instead of measuring store visitation lift of an ad campaign using the ratio of SVR_test and SVR_control, an information sponsor may want to know the actual number of mobile users who have responded to delivered information. This would require a more accurate count of the mobile users with targeted responses after exposure to the information.

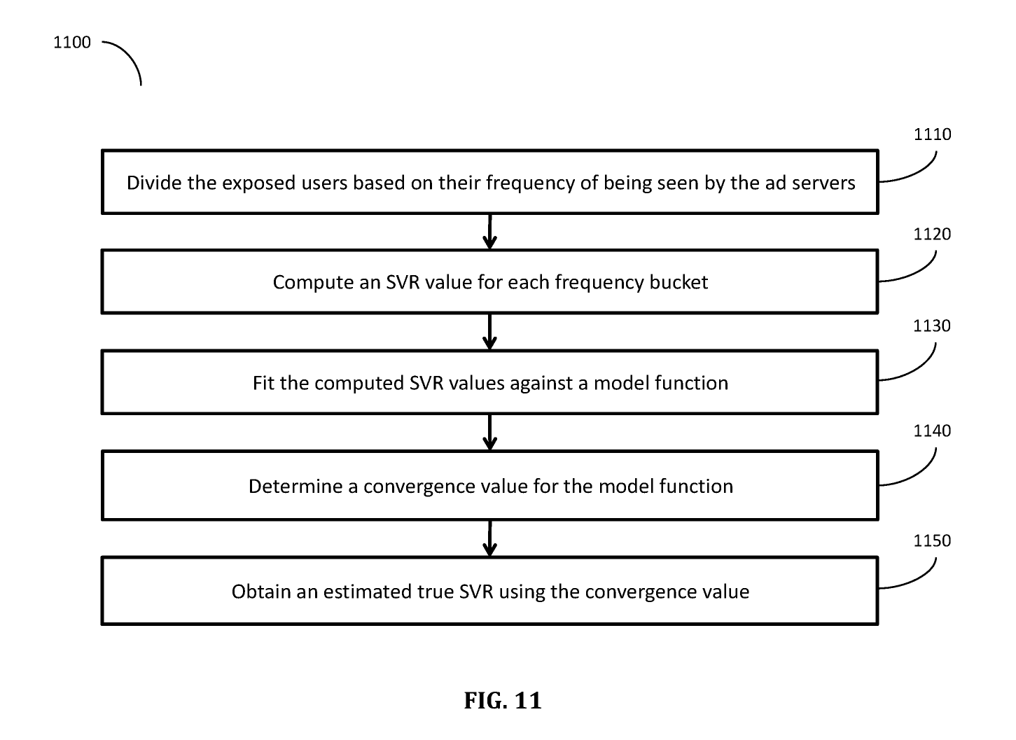

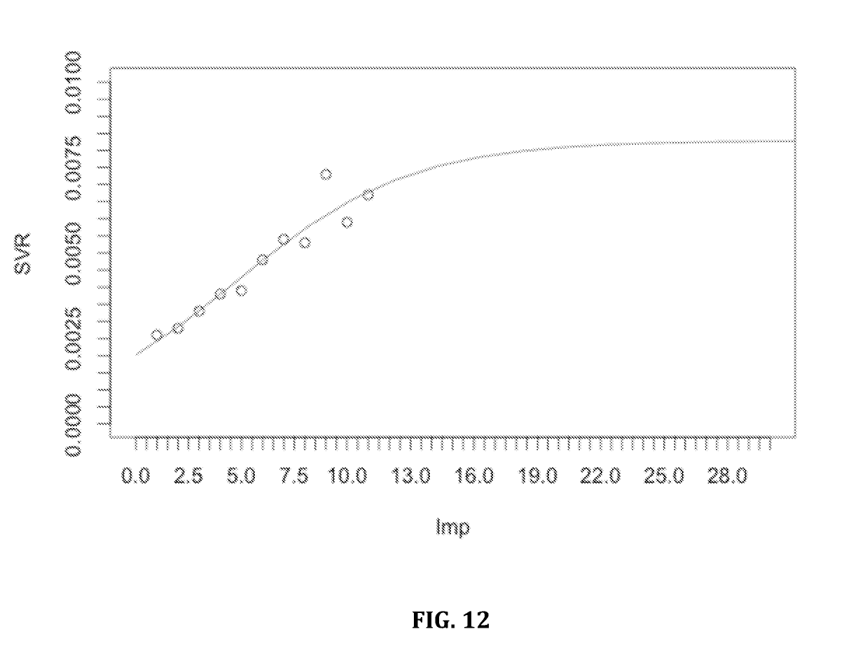

In certain embodiments, a frequency modeling method is used to project a more accurate count of mobile users who visited a target store after ad exposure. As shown in FIG. 11, using a frequency modeling method 1100 according to certain embodiments, the mobile users exposed to an ad campaign are divided (1110) into multiple frequency buckets each associated with a range of frequencies with which a mobile user is seen by the request processing module 310, and an SVR value is computed by the lift analysis module 325 for each of the frequency buckets (1120). In certain embodiments, the frequency may be measured as the number of days requests related to a mobile user show up at the request processing module 310 during a predetermined time window (30 days). Thus, the mobile users who showed up only in one of the 30 days are less likely to be captured during their visits to a targeted store than mobile users who showed up in 10 of the 30 days. Thus, the SVR calculated from the mobile users in the lower frequency bucket would be lower than the SVR calculated from the mobile users in the higher frequency bucket, as shown in FIG. 12.

Referring to FIGS. 11 and 12, the method 1100 further includes fitting the computed SVR values against a model function (1130). For example, the SVR data points in FIG. 12 can be fitted to the following exponential model function:

y=a/(1+exp(−b*x+1)).

By fitting this function to the data points in FIG. 12, with x corresponding to the bucket frequencies (Imp) and y corresponding to the SVR values for the respective buckets, the parameters a and b can be determined. The method 1100 then determines (1140) a convergence value for the model function when x approaches infinity, which in this case is equal to a. The actual SVR for the entire group of mobile users can be estimated (1150) to be this convergence value, which correspond to the projected situation when the ad delivery system can see the mobile users all the times during the predetermined time window. In other words, the plot shown in FIG. 12 is extrapolated to find the SVR of a projected group of users who are seen an infinite number times on an ad serving network.

In certain embodiments, a panel-assisted method is used to estimate the actual SVR. Using this method, an initial panel of qualified mobile users is used to derive a multiplier value that is used in later SVR calculations by the LMS 300. In certain embodiments, the panelists on the initial panel of users are qualified mobile users who have agreed to share their mobile device locations with the LMS 300 at a very high frequency (e.g., one data packet in every 20 minutes or 10 minutes or shorter) by installing and running a designated app in the background on their mobile devices. The designated app on a mobile device is designed to provide the location (e.g., LL) of the mobile device at a predetermined frequency (e.g., every 10 minutes) in the form of, for example, data packets that also include identification of the respective mobile devices and other relevant information. Because of the high frequency of location sharing, most of the store visits by the panelists would be visible to the LMS 300, which now receives two types of incoming data packets, i.e., information requests from information servers, e.g., mobile publishers, ad middleman, and/or ad exchanges, etc., and data packets from panel mobile devices running the designated app.

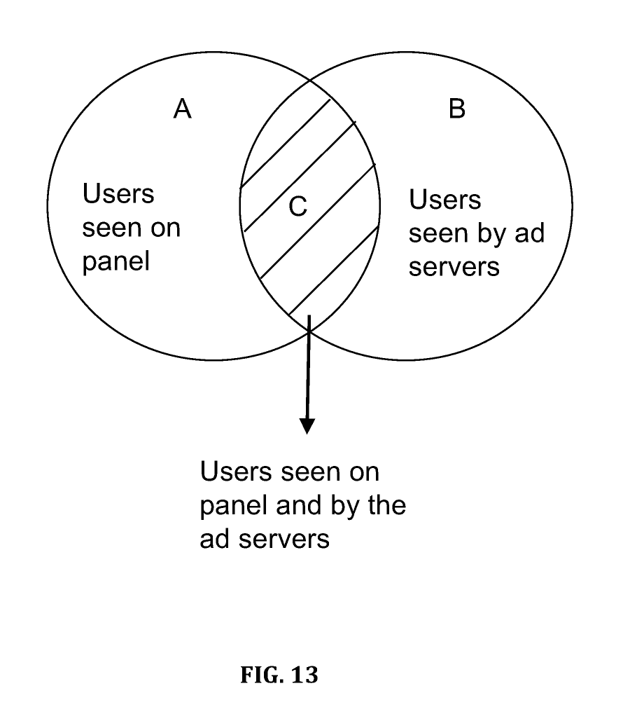

FIG. 13 illustrates three groups of mobile users, Group A being the qualified mobile users on the panel, Group B being qualified mobile users who have been “seen” by the LMS 300 because of associated ad requests, and Group C being mobile users who are in both group A and group B. Thus, Group C are mobile users who have been using apps that send ad requests to the the LMS 300 and who also belong to the panel with the designated app running in the background of their mobile devices. Group C will be used in the panel-assisted method to determine the multiplier value for actual SVR estimation.

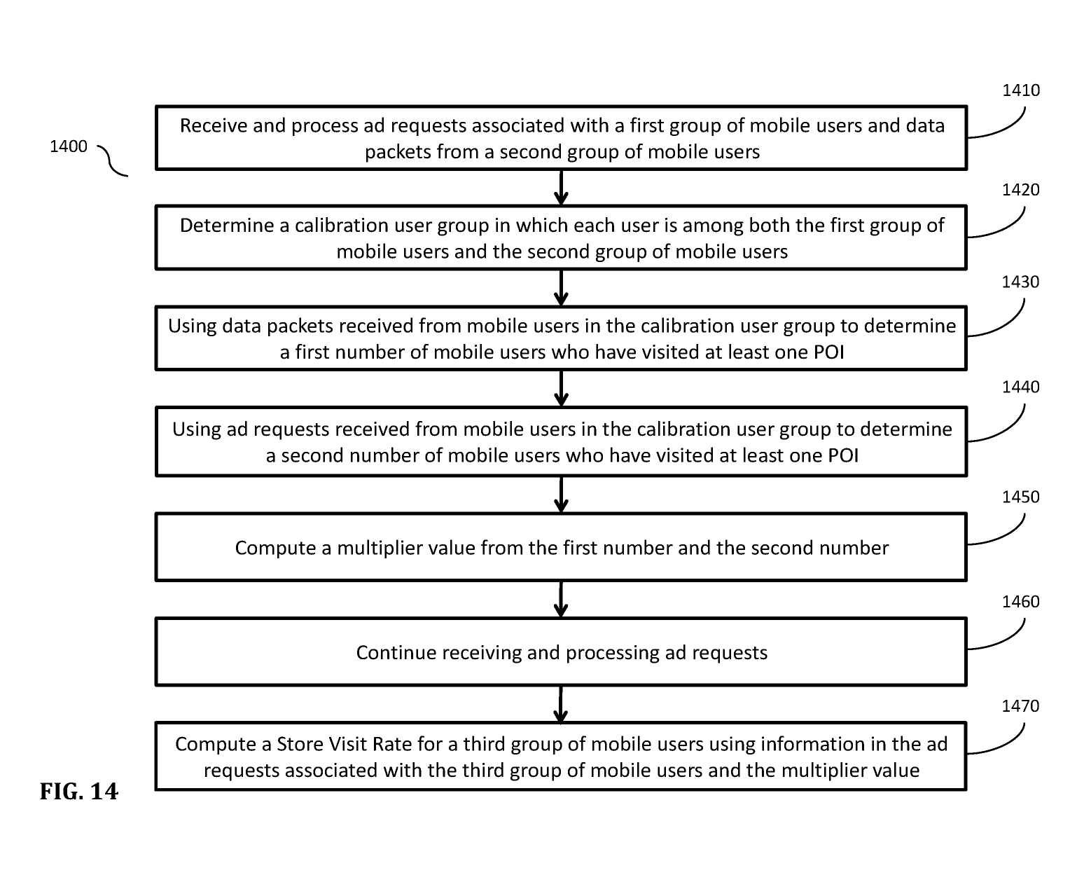

FIG. 14 illustrates a panel-assisted method 1400 for estimating actual SVR according to certain embodiments. As shown in FIG. 14, using the method 1400, the request fulfillment module 315 receives and processes information requests from a first group of mobile users (e.g., Group A), while the calibration module 335 receives and processes panel data packets from a second group of mobile users (e.g., Group B) (1410). The processed information requests are stored in the request log 355, as discussed above. The processed panel data packets can also be stored in the request log 355 or the calibration database 375. The calibration module 335 then determines a calibration user group (Group C) in which each user is among both the first set of mobile users and the second set of mobile users (1420). Using the panel data packets received from mobile users in the calibration user group, the calibration module 335 determines a first number of mobile users who have visited at least one of a set of calibration POI'S selected for calibration purposes (1430). Using information requests received from mobile users in the calibration user group, the calibration module 335 determines a second number of mobile users who have visited at least one of the set of calibration POI'S (1440). Now the first number should be more representative of the actual number of mobile users in the calibration group who have visited the calibration POI'S because their locations are much more frequently shared with the LMS 300. The second number is the number of mobile users seen by the LMS 300 without the designated app. Thus the second number of mobile users are more representative of mobile users that can be tracked without the designated app.

In certain embodiments, the LMS 300 can use the first number and the second number to compute a calibration factor (1450) as an approximate representation, for any group of exposed mobile users, the ratio of the actual number of store visits to the count of store visits that can be detected by the LMS 300 using only ad requests. In certain embodiments, this calibration factor (SVR_multiplier) is simply the ratio of the first number over the second number. This SVR_multiplier is stored in the calibration database and is used in later SVR calculations.

In certain embodiments, any device id (in the form of IDFA, GIDFA) seen from regular ad requests and panel data packets during this time window over a time window of, for example, 90 days, are stored in as key-value stores in the requests Database 355. The key-value stores for ad requests and panel data packets serve as the user store for regular users and panel users respectively. The users who are in both panel user store and regular user store are referred to above as forming the calibration user group. In certain embodiments, a time window (e.g., 1 week) is used as a calibration window, in which the first number of users and the second number of users are counted based on data packets from the designated app and regular ad requests received by LMS 300, respectively.

Thus, as the LMS 300 or its associated ad delivery system continues to receive and process ad requests (1460), it computes SVR for future exposed mobile users (1470) as follows:

SVR=SVR_observed*SVR_multiplier

where SVR_observed is observed SVR based on regular ad request signals captured on the ad servers, as defined in the above, i.e.,

$$SVR = \frac{( Number\_of \_Unique \_Users \_Who \_Visted \_the \_Targeted \_Store )}{( Number\_of \_Unique \_Users \_in \_the \_Group )}$$

The SVR multiplier can be determined at different levels such as region-wise, verticals, brands, and campaigns, as discussed below. In certain embodiments, a different SVR_multiplier is estimated for different business vertical (i.e., a set of related brands). For that purpose, the calibration POI set (i.e., one or more target stores used to measure the SVR) is selected such that only the POIs belonging to one particular vertical or brand (e.g., McDonalds′) is selected to determine that SVR multiplier for that particular vertical or brand.

To determine a region-wise multiplier, the calibration POI set is selected to include all major brands in a geographical region, which can be a country (e.g., United States), a state (e.g., California), a city (e.g., New York), or other municipalities or regions. With such large amount of data, the region-wise (e.g., country-level) multiplier can remain stable across an extended period of time. The region-wise multiplier, however, does not account for specific aspects of ad campaigns that may directly influence the SVR, such as target audience and brand.

To determine a vertical-level multiplier, the calibration POI set is selected to include only POIs belonging to a vertical, e.g., a set (e.g., a category) of brands nationwide The vertical-level multiplier improves upon the country-level multiplier by accounting for potential differences in store visitation among visitors at different types of stores, i.e. restaurants vs retailers. However, the brands within a vertical may exhibit different SVR patterns from each other.

To determine a brand-level multiplier, the calibration POI set is selected to include only POIs associated with one specific brand. As ad campaigns are typically associated with brands, the brand-level multiplier allows for a direct multiplication. However, issues of sparse data begin to appear at this level, especially for international brands. Moreover, the brand-level multiplier is more subject to fluctuation than either the vertical-level or country-level multipliers, given the defined window of ad exposure.

A campaign-level multiplier is equivalent to a brand-level multiplier, except that calculations are restricted to targeted user group defined by a specific ad campaign. The campaign-level multiplier best captures the specific context of an individual campaign, but suffers sometimes from lack of scale.

Thus, each succeeding level captures missed visits more accurately, but may suffer from more fluctuation due to lack of scale.

Within each ad campaign, there may be several ad groups each associated with one or more brands, for which the corresponding multipliers can be applied. For example, for an ad campaign for a brand, there may be an ad group targeting mainly adult male mobile users, an ad group targeting mainly adult female mobile users, a location-based ad group (LBA) targeting mainly mobile users who are determined to be in one or more specified places, and on-premise ad group targeting mainly mobile users who are determined to be on the premise associated with the brand. In certain embodiments, a two step-process is used to derive the SVR for this ad campaign. First, a SVR_multiplier is determined for each of the ad groups, except the location-based ad groups (LBAs) and the on-premise ad groups, which are excluded from the need for an SVR multiplier because these audiences have already been previously seen visiting the stores via ad requests and panel data packets, thus are less likely to exhibit lost visits. Afterwards, a weighted average can be taken to derive the final SVR.

This method is applicable to ad campaigns with both low and high observed SVRs. For the former type, the calculation can simplify be performed by applying the brand-level multipliers due to the lack of LBAs. For instance, consider an ad campaign for Subway with an observed SVR of 0.39 percent. For this campaign, using the country-level multiplier of 3.9 results in a SVR of 1.54 percent, which is likely an underestimation given historical data. Indeed, panel-based analysis indicates that request-based tracking is underestimating count of visit to Subway by a factor of approximately 16. Because this campaign has no LBAs, a brand-level multiplier of 15 can simply be applied to the observed SVR to yield 5.86 percent, a result more in line with expectations.

In another example, consider an ad campaign for four retailers—Target, Walgreens, CVS, and Rite Aid—with a relatively high observed SVR of 7 percent. Using the country-level multiplier SVR estimation, the reported SVR would be overestimated at 28 percent. Using the new method with brand-level multipliers and exclusion of LBAs, SVR is calculated to be a more reasonable 16 percent. Use of brand-level multipliers also yields more insight regarding store visitation patterns at these brands.

In certain embodiments, the SVR estimation is modeled as a typical Bernoulli process, where each user has a given probability of p to visit a store. The confidence interval for this e p estimation is therefore:

±z\sqrt{\hat{p}(1−\hat{p})/n}

where z is 1.96 for 95% confidence level, \hat{p} is the observed store visitation rate SVR. In the case of applying a multiplier to the observed SVR for projection purpose, the same multiplier is applied to the confidence interval.

We claim:

1. A method performed by one or more computer systems coupled to a packet-based network, comprising:
receiving panel data packets via the packet-based network, each panel data packet including a location of one of a pre-selected panel of mobile devices that transmits panel data packets at a specific frequency;
receiving a first plurality of request data packets via the packet-based network, each request data packet in the first plurality of request data packets representing a request for information and including request data related to one of a first plurality of mobile devices coupled to the packet-based network, the request data including location data indicative of a location of the one of the first plurality of mobile devices;
selecting a set of calibration mobile devices from the first plurality of mobile devices, each calibration mobile device in the set of calibration mobile devices having transmitted at least one of the panel data packets;
using panel data packets transmitted by the set of calibration mobile devices to determine a first number of calibration mobile devices having visited at least one of one or more pre-defined calibration places;
using request data packets related to the set of calibration mobile devices to determine a second number of calibration mobile devices having visited at least one of the one or more pre-defined calibration places;
computing a calibration factor using the first number and the second number;
receiving a second plurality of request data packets via the Internet, each request data packet in the second plurality of request data packets representing a request for information and including request data related to one of a second plurality of mobile devices coupled to the packet-based network;
processing the second plurality of request data packets, resulting a first number of mobile devices among the second plurality of mobile devices being impressed with information associated with a specific campaign;
receiving a third plurality of request data packets via the Internet, each request data packet in the third plurality of request data packets including request data related to one of a third plurality of mobile devices coupled to the packet-based network;
tracking the first number of impressed mobile devices using the third plurality of request data packets to determine a second number of impressed mobile devices having visited at least one of one or more pre-defined places associated with the specific campaign; and
deriving a measure of performance of the specific campaign using the first number, the second number and the calibration factor.

2. The method of claim 1, wherein processing the second plurality of request data packets comprises, for each respective data packet in the second plurality of request data packets: (1) processing the request data in the respective request data packet with respect to a spatial index database; (2) storing processed request data in a request database, the processed request data including at least some of the request data, and at least one place identifier identifying at least one place in which a related mobile device is estimated to be; (3) determining whether to fulfill the request represented by the respective data packet based on the processed request data and one or more sets of criteria; and (4) in response to the determination to fulfill the request represented by the respective data packet, transmitting a bidding data packet including at least some of the processed request data and a link to information associated with a matching campaign to at least one information server via the packet-based network, receiving feedback from the at least one information server regarding whether the related mobile device has been impressed with the information associated with the matching campaign in response to the bidding data packet, and storing the feedback in an impression database

3. The method of claim 1, wherein the specific frequency is measured as one panel data packet in every predetermined time period, and wherein the predetermined time period is equals to or shorter than 20 minutes.

4. The method of claim 3, wherein the predetermined time period is equals to or shorter than 10 minutes.

5. The method of claim 1, wherein the one or more pre-defined calibration places include all places in a geographical region that are identified in the spatial index database.

6. The method of claim 5, wherein the geographical region is a country.

7. The method of claim 5, wherein the geographical region is a municipality.

8. The method of claim 1, wherein the one or more pre-defined calibration places include all places in a geographical region that are identified in the spatial index database and that are associated with a set of one or more brands.

9. The method of claim 1, wherein the one or more pre-defined calibration places are defined by the specific campaign.

10. The method of claim 1, wherein each of the first number of calibration mobile devices and the second number of calibration mobile devices meet a set of campaign criteria associated with the specific campaign.

11. A method performed by one or more computer systems coupled to a packet-based network, comprising:
receiving a first plurality of data packets via the Internet, each data packet in the first plurality of data packets representing a request for information and including request data related to one of a first plurality of mobile devices coupled to the packet-based network, the request data including location data indicative of a location of the one of the first plurality of mobile devices;
processing the first plurality of request data packets, resulting in a first group of mobile devices among the first plurality of mobile devices to be impressed with information associated with a specific campaign and a second group of mobile devices among the first plurality of mobile devices to be qualified for the specific campaign yet not served with any information associated with the specific campaign;
receiving a second plurality of data packets via the Internet, each data packet in the second plurality of data packets including request data related to one of a second plurality of mobile devices coupled to the packet-based network;
tracking the first group of mobile devices and the second group of mobile devices using the second plurality of data packets to determine a first number of mobile devices among the first group of mobile devices having visited one of one or more places associated with the specific campaign and a second number of qualified mobile devices among the second group of mobile devices having visited one of the one or more places; and
deriving a measure of performance of the specific campaign using the first number and the second number.

12. The method of claim 11, wherein processing the first plurality of data packets comprises, for each respective data packet in the first plurality of data packets: (1) processing the corresponding request data with respect to a spatial index database; (2) storing processed request data in a request database, the processed request data including at least some of the request data, and at least one place identifier identifying at least one place in which a related mobile device is estimated to be; (3) determining whether to fulfill the request represented by the respective data packet based on the processed request data and one or more sets of criteria; and (4) in response to the determination to fulfill the request represented by the respective data packet, transmitting a bidding data packet including the processed request data and a link to information associated with a matching campaign to at least one information server via the packet-based network, receiving feedback from the at least one information server regarding whether the request for information associated with the respective data packet has been fulfilled, and storing the feedback in an impression database.

13. The method of claim 11, wherein the one or more sets of criteria include campaign criteria stored in a campaign database.

14. The method of claim 11, wherein the one or more sets of criteria include criteria in accordance with a hash function built in the one or more computer systems for the specific campaign.

15. The method of claim 14, wherein the one or more sets of criteria include criteria in accordance with a number recorded by a counter built in the one or more computer system, the number indicating a difference between a number of fulfilled requests related to the specific campaign and a number of unfulfilled requests related to the campaign, the number of unfulfilled requests being excluded by the hash function.

16. The method of claim 11, wherein the first plurality of data packets are received during a first window of time and the second plurality of data packets are received during a second window of time, the first window of time overlapping with the second window of time.

17. The method of claim 11, further comprising:
receiving a third plurality of data packets via the packet-based network during a time window before receiving the first plurality of data packets, each data packet in the third plurality of data packets being associated with a request for information and including request data related to one of a third plurality of mobile devices coupled to the packet-based network, the request data including location data indicative of a location of the one of the first plurality of mobile devices, the third plurality of mobile devices include at least some of the group of exposed mobile devices and at least some of the group of qualified mobile devices;
determining a third number of exposed mobile devices among the at least some of the group of exposed mobile devices having visited one of the one or more places associated with the specific campaign during the time window and a fourth number of qualified mobile devices the at least some of the group of qualified mobile devices having visited one of the one or more places during the time window; and
wherein the measure of performance of the specific campaign is derived using the first number, the second number, the third number and the fourth number.

18. A method performed by one or more computer systems coupled to a packet-based network to measure performance of a mobile advertisement (ad) campaign, the method comprising:
receiving a first plurality of data packets via the packet-based network, each data packet in the first plurality of data packets representing a request for information and including request data related to one of a first plurality of mobile devices coupled to the packet-based network, the request data including location data indicative of a location of the one of the first plurality of mobile devices;
processing the first plurality of data packets, resulting in a second plurality of mobile devices among the first plurality of mobile devices being served information associated with a specific campaign;
dividing the second plurality of mobile devices into a plurality of groups, each respective group of the plurality of subgroups corresponding to a respective range of frequencies such that each mobile device in a respective group is related to a set of data packets among the first plurality of data packets, wherein the set of data packets have been received by the one or more computer systems at a frequency in the respective frequency range;
for each group of the plurality of groups, determining a number of a subset of mobile devices in the each group that have visited one of one or more places associated with the specific campaign based on request data in the data packets associated with the mobile devices in the each group, and derive a respective visit rate for the each group using the number of the subset of mobile devices; and
fitting the respective rates of the plurality of groups to a model function; and
extrapolating a measure of the performance of the specific campaign from the model function.

19. The method of claim 18, wherein processing the first plurality of data packets comprises, for each respective data packet in the first plurality of data packets: (1) processing the corresponding request data with respect to a spatial index database; (2) storing processed request data in a request database, the processed request data including at least some of the request data, and at least one place identifier identifying at least one place in which a related mobile device is estimated to be; (3) determining whether to fulfill the request for information associated with the respective data packet based on the processed request data and one or more sets of criteria; and (4) in response to the determination to fulfill the request for information associated with the respective data packet, transmitting a bidding data packet including the processed request data and information associated with a matching campaign to at least one information server via the packet-based network, receiving feedback from the at least one information server regarding whether the related mobile device has been impressed with the information associated to the matching campaign in response to the bidding data packet, and storing the feedback in an impression database.

20. The method of claim 19, wherein the number of the subset of mobile devices in the each group is determined using data stored in the request database and the impression database.
